(19) United States
(12) Patent Application Publication
(10) Pub. No.: US 2023/0090374 A1
(43) Pub. Date: Mar. 23, 2023

(54) WAVEGUIDE HEAD-UP DISPLAY

(71) Applicant: GM Global Technology Operations LLC, Detroit, MI (US)

(72) Inventors: Thomas A. Seder, Fraser, MI (US); Kai-Han Chang, Madison Heights, MI (US)

(21) Appl. No.: 17/481,909

(22) Filed: Sep. 22, 2021

(51) Int. Cl. G02B 27/01; G09G 3/00; G02F 1/29

(52) U.S. Cl. CPC G02B 27/0149; G09G 3/002; G02B 27/0103; G02F 1/29; G09G 2380/10; G09G 2354/00; G02B 2027/0154

(57) ABSTRACT

A head-up display system includes a hologram projector adapted to project a holographic image, a beam steering device adapted to adjust a look down angle of a holographic image projected through the beam steering device by the hologram projector, and a controller in communication with the hologram projector and adapted to compare the vertical location of the driver's eyes to a pre-determined nominal vertical position, and to adjust a virtual image distance of the holographic image projected by the hologram projector.

### INTRODUCTION

The present disclosure relates to a head-up display and more particularly to a system and method for modifying placement of a holographic image to maintain proper virtual positioning of projected images for a driver relative to an actual road surface.

A head-up display (HUD) has become common in modern automobiles. HUDs project useful information like speed and navigation information into the driver's field of view. This avoids forcing the driver to look down, away from the road, to read gages on the dash of the automobile. This reduces driver distractions and keeps the driver's eyes on the road.

New HUD systems may include projecting augmented reality images, such as optimal travel paths or navigation arrows to provide images that appear to be on the actual road surface. Unfortunately, HUD systems with such capability are set up to provide accurate placement for the “nominal driver”. To ensure that a driver sees such projected images at the proper location on the road surface, the position of the projected image must be adjusted to accommodate for varying heights of the vehicle and varying vertical location of the driver's eyes relative to the HUD system.

Traditional HUD systems have a fixed look down angle (LDA) and virtual image distance (VID), and thus compensate for varying heights of the vehicle and varying vertical location of the driver's eyes by adjusting the vertical field of view (FOV) and changing placement of the projected image within the FOV as eye height or ride height changes. Increasing the size of the FOV results in unreasonably large HUD systems which create packaging issues within the automobile.

Thus, while current HUD systems and methods achieve their intended purpose, there is a need for a new and improved HUD system and method for utilizing both a variable LDA and variable VID to accommodate eye height and ride height changes in an automobile to ensure proper perceived location of virtual images on a road by the driver.

### SUMMARY

According to several aspects of the present disclosure, a method of controlling a head up display system for an automobile includes locating, with a driver monitoring system, the vertical location of a driver's eyes, comparing, with a controller, the vertical location of the driver's eyes to a pre-determined nominal vertical location, adjusting, with a beam steering device, a look down angle of a holographic image projected by a hologram projector, and adjusting, with the controller, a virtual image distance of the holographic image projected by the hologram projector.

According to another aspect, the comparing, with the controller, the vertical location of the driver's eyes to the pre-determined nominal vertical location, further includes, determining the distance that the vertical location of the driver's eyes varies from the pre-determined nominal vertical location.

According to another aspect, the adjusting, with the beam steering device, the look down angle, further includes adjusting, with a beam steering device that includes a liquid crystal lens adapted to steer light passing through the beam steering device upon application of voltage to the beam steering device, the look down angle.

According to another aspect, the adjusting, with the beam steering device that includes a liquid crystal lens adapted to steer light passing through the beam steering device upon application of voltage to the beam steering device, the look down angle, further includes selectively changing birefringent characteristics of the liquid crystal lens by varying the voltage supplied to the liquid crystal.

According to another aspect, the adjusting, with the beam steering device that includes a liquid crystal lens adapted to steer light passing through the beam steering device upon application of voltage to the beam steering device, the look down angle, further includes selectively changing the orientation of liquid crystal molecules within the liquid crystal lens by varying the voltage supplied to the liquid crystal lens.

According to another aspect, the selectively changing the orientation of liquid crystal molecules by varying the voltage supplied to the liquid crystal lens further includes, rotating the liquid crystal molecules about an axis that is parallel to a direction of the light entering the beam steering device.

According to another aspect, the selectively changing the orientation of liquid crystal molecules by varying the voltage supplied to the liquid crystal lens further includes, rotating the liquid crystal molecules about an axis that is perpendicular to a direction of the light entering the beam steering device.

According to another aspect, the adjusting, with the beam steering device, a look down angle, further includes adjusting, with a beam steering device that includes a first circular wedge prism and a second circular wedge prism adapted to steer light passing through the beam steering device upon rotation of the first circular wedge prism and the second circular wedge prism, the look down angle.

According to another aspect, the adjusting, with the beam steering device that includes a first circular wedge prism and a second circular wedge prism adapted to steer light passing through the beam steering device upon rotation of the first circular wedge prism and the second circular wedge prism further includes, selectively rotating the first circular wedge prism and the second circular wedge prism about an axis parallel to a direction of the light entering the beam steering device.

According to several aspects of the present disclosure, a head-up display system includes a hologram projector adapted to project a holographic image, a beam steering device adapted to adjust a look down angle of a holographic image projected through the beam steering device by the hologram projector, and a controller in communication with the hologram projector and adapted to compare the vertical location of the driver's eyes to a pre-determined nominal vertical location, and to adjust a virtual image distance of the holographic image projected by the hologram projector.

According to another aspect, the controller is further adapted to determine a distance that the vertical location of the driver's eyes varies from the pre-determined nominal vertical location.

According to another aspect, the beam steering device includes a liquid crystal lens adapted to steer light passing through the beam steering device upon application of voltage to the beam steering device.

According to another aspect, the liquid crystal lens is adapted to selectively change birefringent characteristics of the beam steering device when voltage supplied to the liquid crystal lens is varied by the controller.

According to another aspect, the liquid crystal lens is adapted to selectively steer light passing through the beam steering device by changing the orientation of liquid crystal molecules within the liquid crystal lens when voltage supplied to the liquid crystal lens is varied by the controller.

According to another aspect, the liquid crystal molecules within the liquid crystal lens are rotated about an axis that is parallel to a direction of light entering the beam steering device.

According to another aspect, the liquid crystal molecules within the liquid crystal lens are rotated about an axis that is perpendicular to a direction of light entering the beam steering device.

According to another aspect, the beam steering device includes a first circular wedge prism and a second circular wedge prism, wherein the first circular wedge prism and the second circular wedge prism are adapted to steer light passing through the beam steering device upon rotation of the first circular wedge prism and the second circular wedge prism.

According to another aspect, the first circular wedge prism and the second circular wedge prism are selectively and independently rotatable about an axis parallel to a direction of light entering the beam steering device.

According to another aspect, the controller is adapted to adjust a virtual image distance by encoding a lens function into the holographic image projected by the hologram projector.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic illustration of a head-up display system according to an exemplary embodiment;

FIG. 2A is a schematic diagram illustrating varying image positions based on varying vertical eye positions when an LDA and VID are fixed;

FIG. 2B is an enlarged portion of FIG. 2A, and indicated at “FIG. 2B” in FIG. 2A;

FIG. 3 is a schematic diagram illustrating consistent image positions based on varying vertical eye positions when the LDA is adjusted and the VID is fixed;

FIG. 4A is a schematic view of a liquid crystal lens for a beam steering device, wherein a holographic image passes through the bean steering device un-deflected;

FIG. 4B is a schematic view of the liquid crystal lens shown in FIG. 4A wherein the holographic image is deflected upward;

FIG. 4C is a schematic view of the liquid crystal lens shown in FIG. 4A wherein the holographic image is deflected downward;

FIG. 5A is a schematic view of a liquid crystal lens for a beam steering device according to another embodiment, wherein a holographic image passes through the bean steering device un-deflected;

FIG. 5B is a schematic view of the liquid crystal lens shown in FIG. 5A wherein the holographic image is deflected either upward or downward;

FIG. 6 is a schematic view of a beam steering device including a first wedge prism and a second wedge prism;

FIG. 7 is a schematic diagram illustrating consistent image positions based on varying vertical eye positions when both the LDA and the VID are adjusted; and

FIG. 8 is a flow chart illustrating a method of controlling a heads-up display in accordance with the present disclosure.

### DETAILED DESCRIPTION

The following description is merely exemplary in nature and is not intended to limit the present disclosure, application, or uses.

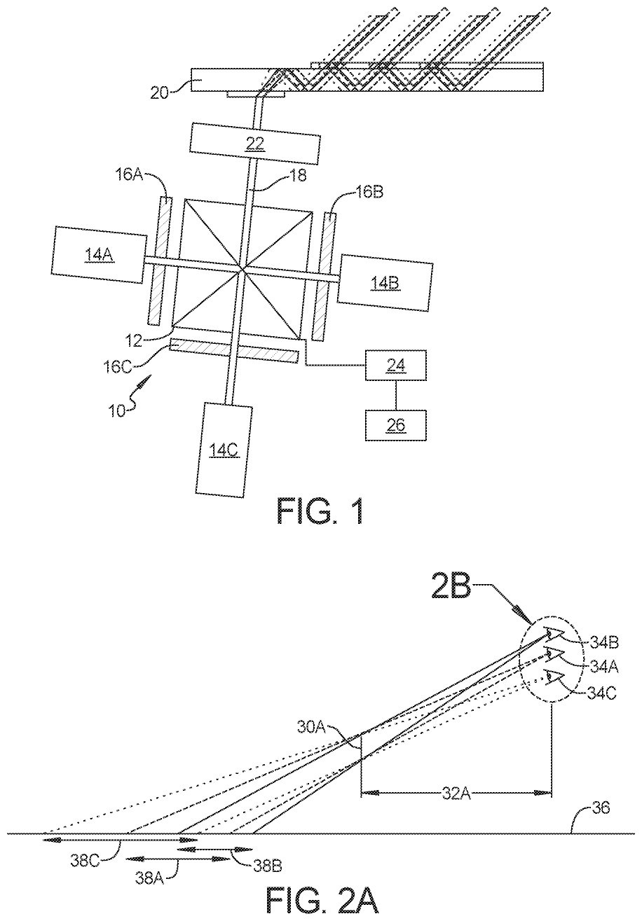

Referring to FIG. 1, a head-up display (HUD) system 10 according to the present disclosure includes a hologram projector 12 that is adapted to project a holographic image 18. In an exemplary embodiment, the hologram projector 12 includes a red laser 14A and a first spatial light modulator 16A associated with the red laser 14A, a green laser 14B and a second spatial light modulator 16B associated with the green laser 14B, and a blue laser 14C and a third spatial light modulator 16C associated with the blue laser 14C. Each of the red, green and blue lasers 14A, 14B, 14C project through the associated spatial light modulators 16A, 16B, 16C and collimated into a holographic image 18 that is projected outward.

In an exemplary embodiment, the hologram projector 12 includes a pupil expander 20 or wave guide. The holographic image 18 is projected into the pupil expander 20 and then propagates inside the pupil expander 20 and is extracted multiple times. The re-circulation of the light several times within the pupil expander 20 expands the pupil so the viewer can see the holographic image 18 from an extended eye-box. In addition to expanding the eye-box, the pupil expander 20 also magnifies the original projected image coming out of the hologram projector 12.

A beam steering device 22 is positioned between the hologram projector 12 and the pupil expander 20. The beam steering device 22 is adapted to adjust a look down angle (LDA) of the holographic image 18 projected through the beam steering device 22 by the hologram projector 12. In optical systems, beam steering may be accomplished by changing the refractive index of the medium through which the beam is transmitted or by the use of mirrors, prisms, lenses, or rotating diffraction gratings. Examples of optical beam steering approaches include mechanical mirror-based gimbals or beam-director units, galvanometer mechanisms that rotate mirrors, Risley prisms, phased-array optics, and microelectromechanical systems (MEMS) using micro-mirrors. A controller 24 is in communication with the hologram projector 12 and is adapted to compare the vertical location of the driver's eyes to a pre-determined nominal vertical location, and to adjust a virtual image distance (VID) of the holographic image 18 projected by the hologram projector 12.

The controller 24 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

In an automobile, the controller 24 obtains information of the position of the eyes of a driver of the automobile from a driver monitoring system 26 within the automobile. The driver monitoring system 26 uses cameras to identify the facial features of the driver and provides information on the vertical location of the eyes of the driver to the controller 24.

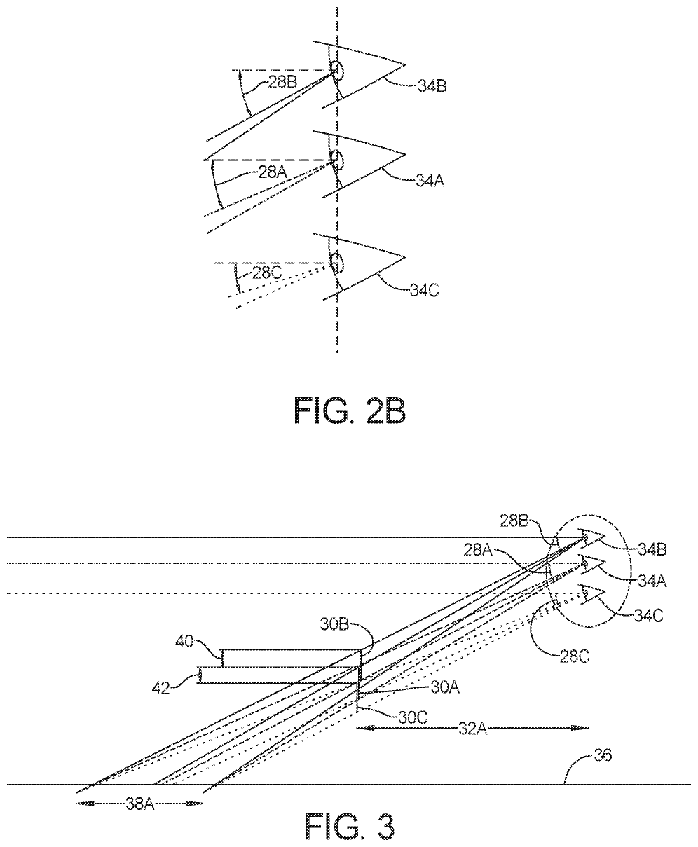

Referring to FIG. 2A and FIG. 2B, traditional HUD systems have a fixed look down angle (LDA) and virtual image distance (VID). The LDA 28 is the angle at which the eyes of a driver are oriented relative to the virtual image 30. The virtual image 30 is the image that is projected to the eyes of the driver. The VID 32 is the distance from the driver's eyes the virtual image 28 is perceived by the driver. Since the LDA 28 and the VID 32 are typically fixed, HUD systems are designed for a nominal driver. In FIG. 2A, the vertical position of the nominal driver's eyes is indicated at 34A. The VID 32 is fixed. The nominal LDA is established at 28A, as shown in FIG. 2B. The nominal driver perceives the virtual image 30 on the road surface 36 at position 38A. The vertical position of a taller driver's eyes is indicated at 34B. The taller driver perceives the virtual image 30 at position 38B due to the steeper LDA 28B. Because of the steeper LDA 28B, the taller driver perceives the virtual image 30 at position 38B. Similarly, the vertical position of a shorter driver's eyes is indicated at 34C. The shorter driver perceives the virtual image 30 at position 38C due to the shallower LDA 28C. Because of the shallower LDA 28C, the taller driver perceives the image at position 38C.

The controller 24 is adapted to determine the distance that the vertical location of the driver's eyes varies from the pre-determined nominal vertical position 34A. Based on the distance at which the driver's eyes are either higher or lower than the nominal vertical position 34A, the beam steering device 22 is adapted to adjust the look down angle (LDA) of the holographic image 18 projected through the beam steering device 22 by the hologram projector 12.

Referring to FIG. 3, the vertical position of the nominal driver's eyes is indicated at 34A. The VID is fixed and indicated at 32. The nominal LDA is established at 28A. The nominal driver perceives the virtual image 30A at position 38A. The vertical position of a taller driver's eyes is indicated at 34B. The LDA is adjusted by changing the vertical location of the virtual image 30B presented to the taller driver. The virtual image 30B is moved upward a distance, as indicated at 40, to account for the higher vertical position of the taller driver's eyes. Thus, the taller driver perceives the virtual image 30 at position 38A, the same as the nominal driver. The vertical position of a shorter driver's eyes is indicated at 34C. The LDA is adjusted by changing the vertical location of the virtual image 30 presented to the shorter driver. The virtual image 30 is moved downward a distance, as indicated at 42, to account for the lower vertical position of the shorter driver's eyes. Thus, the shorter driver perceives the image at position 38A, the same as the nominal driver.

In an exemplary embodiment, the beam steering device 22 includes a liquid crystal lens 44 adapted to steer light passing through the beam steering device 22 upon application of voltage to the beam steering device 22. Once the controller 24 determines how much higher or lower the driver's eyes are in relation to the nominal vertical eye location 34A, the controller 24 will provide an appropriate amount of voltage to the liquid crystal lens 44 to steer the projected holographic image 18 passing through the beam steering device 22 and change the vertical location of the virtual image 30 projected to the driver. The liquid crystal lens 44 is adapted to selectively change birefringent characteristics of the beam steering device 22 when voltage supplied to the liquid crystal lens 44 is varied by the controller 24.

Birefringence is the optical property of a material having a refractive index that depends on the polarization and propagation direction of light. By changing the birefringent characteristics of a material, the refraction of the light passing through such material is altered and will project outward at a different angle. By adjusting the birefringent characteristics of the liquid crystal lens 44, the beam steering device 22 can be tuned to move the virtual image 30 upward or downward vertically based on the vertical position of the driver's eyes.

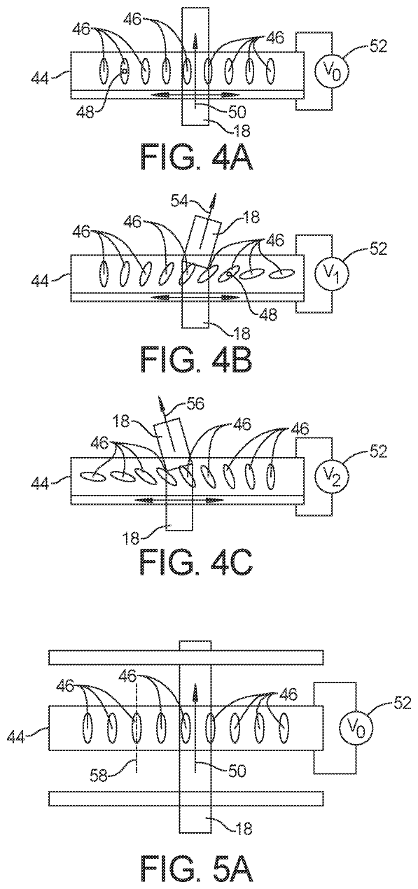

In an exemplary embodiment, the birefringent characteristics of the liquid crystal lens 44 are manipulated by changing the orientation of liquid crystal molecules 46 within the liquid crystal lens 44 when voltage supplied to the liquid crystal lens 44 is varied by the controller 24. Referring to FIG. 4A, a liquid crystal lens 44 is shown wherein the liquid crystal molecules 46 within the liquid crystal lens 44 are rotated about an axis 48 that is perpendicular to a direction, indicated by arrow 50, of light entering the beam steering device 22. A voltage source 52 provides electrical field to the liquid crystal lens 44. As shown in FIG. 4A, when the voltage is zero, V₀, the liquid crystal molecules 46 are oriented along the path 50 of the light entering the liquid crystal lens 44, and the light passing through the beam steering device 22 is not reflected by the beam steering device 22. Referring to FIG. 4B, when a taller driver is driving the vehicle, the voltage, V₁, is adjusted by the controller 24 such that the liquid crystal molecules 46 rotate about the axis 48 that is perpendicular to the path 50 of light entering the beam steering device 22, wherein the liquid crystal molecules 46 deflect the holographic image 18 upward, as shown by arrow 54. Similarly, referring to FIG. 4C, when a shorter driver is driving the vehicle, the voltage, V₂, is adjusted by the controller 24 such that the liquid crystal molecules 46 rotate about the axis 48 in an opposite direction, wherein the liquid crystal molecules 46 deflect the holographic image 18, as shown by arrow 56.

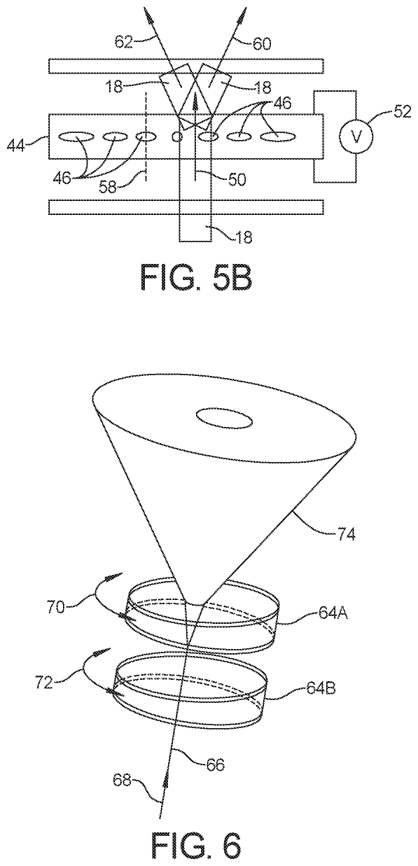

Referring to FIG. 5A, a liquid crystal lens 44 is shown wherein the liquid crystal molecules 46 within the liquid crystal lens 44 are rotated about an axis 58 that is parallel to the path 50 of the holographic image 18 entering the beam steering device 22. Methods of beam steering in this manner include, but are not limited to, active geometric phase grating reacting to circular polarization of light.

A voltage source 52 provides electrical field to the liquid crystal lens 44. As shown in FIG. 5A, when the voltage is zero, V₀, the liquid crystal molecules 46 are oriented along the path 50 of the holographic image 18, and the holographic image 18 passing through the beam steering device 22 is not reflected by the beam steering device 22. Referring to FIG. 5B, when a taller or shorter driver is driving the vehicle, the voltage, V, is adjusted by the controller 24 such that the liquid crystal molecules 46 rotate about the axis 58, wherein the liquid crystal molecules 46 deflect the holographic image 18 entering the beam steering device 22 upward, as shown by arrow 60, or downward, as shown by arrow 62, as the case may be.

Referring to FIG. 6, in another exemplary embodiment, the beam steering device 22 includes an Alvarez lens including a first circular wedge prism 64A and a second circular wedge prism 64B. The first circular wedge prism 64A and the second circular wedge prism 64B are adapted to steer the holographic image 18 passing through the beam steering device 22 upon rotation of the first circular wedge prism 64A and the second circular wedge prism 64B. As shown in FIG. 6, the first circular wedge prism 64A and the second circular wedge prism 64B are selectively and independently rotatable about an axis 66 that is parallel to a direction of the holographic image 18 entering the beam steering device 22, as indicated by 68. By rotating the first circular wedge prism 64A, as indicated by arrow 70, and the second circular wedge prism 64B, as indicated by arrow 72, the holographic image 18 passing through the beam steering device 22 can be adjusted two-dimensionally anywhere within a conical area 74. In this way, the virtual image 30 can be adjusted vertically to account for varying vertical locations of the driver's eyes by adjusting the LDA 28. One advantage of the embodiment shown in FIG. 6 is that the virtual image 30 can be adjusted both vertically and horizontally anywhere within the conical area 74.

Varying the LDA 28 to accommodate varying vertical eye locations provides the same visual road coverage and graphic location for all drivers. Varying the LDA 28 is possible in any waveguide HUD system, wherein the beam steering device 22 changes the hologram-waveguide input angle. However, the range of input angles is limited by efficiency loss and is relatively small, on the order of ±2 degrees. Therefore, varying the LDA 28 with a beam steering device 22 may not fully compensate for the outliers (extremely tall or short drivers). Thus, in an exemplary embodiment, in conjunction with varying the LDA 28, the HUD system 10 is further adapted to adjust, with the controller 24, a virtual image distance (VID) 32 of the virtual image 30 projected by the hologram projector 12.

The virtual image distance is the focal distance where the virtual image 30 appears to reside. The apparent distance between the driver's eyes and the virtual image 30 created by the HUD optics. Typically, the virtual image 30 is created well beyond the windshield of the vehicle. The VID 32 is controlled and can be adjusted by using the controller to encode a lens function into the holographic image 18 projected by the hologram projector 12.

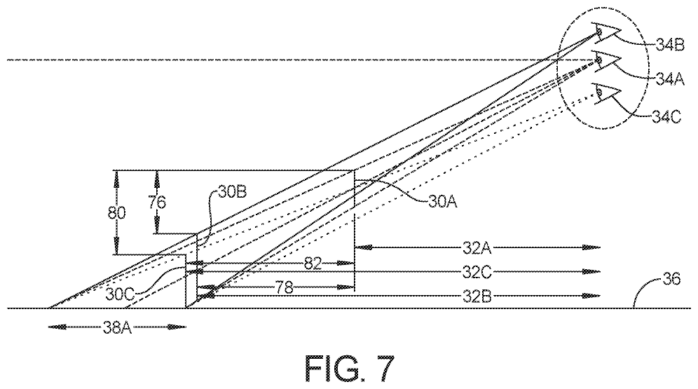

Referring to FIG. 7 and FIG. 3, the vertical position of the nominal driver's eyes is indicated at 34A. The nominal LDA is established at 28A. The nominal VID is established at 32A. The nominal driver perceives the image at position 38A. The vertical position of a taller driver's eyes is indicated at 34B. The LDA is adjusted by changing the vertical position of the virtual image 30, and the VID 32B is adjusted by changing the horizontal location of the virtual image 30 presented to the taller driver. The virtual image 30B is moved downward a distance, as indicated at 76, and forward a distance, as indicated at 78, to account for the higher vertical position of the taller driver's eyes. Thus, the taller driver perceives the holographic image 18 at position 38A, the same as the nominal driver. The vertical position of a shorter driver's eyes is indicated at 34C. The LDA is adjusted by changing the vertical position of the virtual image 30, and the VID 32C is adjusted by changing the horizontal location of the virtual image 30C presented to the shorter driver. The virtual image 30C is moved downward a distance, as indicated at 80, and forward a distance, as indicated at 82, to account for the lower vertical position of the shorter driver's eyes. Thus, the shorter driver perceives the image at position 38A, the same as the nominal driver.

Adjusting either of the LDA or the VID alone may not accommodate for possible extreme variations of the vertical position of a driver's eyes. By adjusting both the LDA and the VID, a broader range of variance may be accommodated.

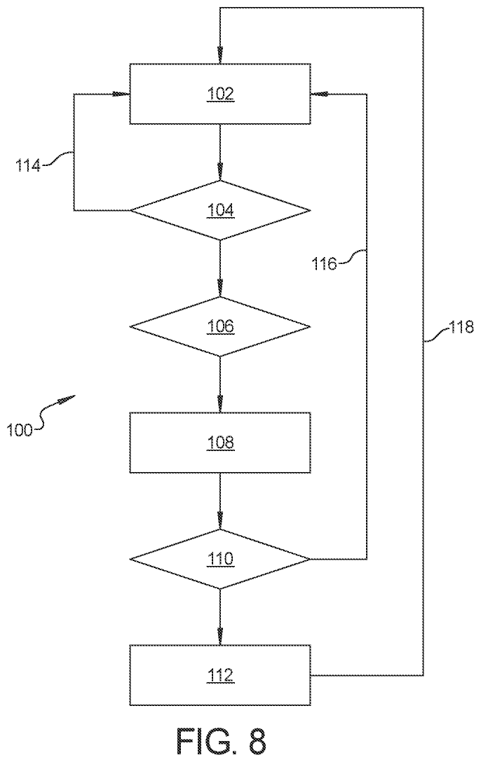

Referring to FIG. 8, a method of controlling a head-up display system for an automobile is illustrated at 100. Starting at block 102, the method includes locating, with the driver monitoring system 26, the vertical location of a driver's eyes. Moving to block 104, the method further includes comparing, with the controller 24, the vertical location of the driver's eyes to a pre-determined nominal vertical position 34A. If the vertical location of the driver's eyes are located at or within a pre-determined distance from the nominal vertical position 34A, the method 100 loops back to block 102, as indicated by arrow 114.

If the vertical location of the driver's eyes are outside the pre-determined distance above or below the nominal vertical position 34A, moving to block 106, determining the distance that the vertical location of the driver's eyes varies from the pre-determined nominal vertical position 34A and, moving to block 108, based on the amount of variance of the vertical location of the driver's eyes from the nominal vertical position 34A, adjusting, with the beam steering device 22, the LDA of the holographic image 18 projected by the hologram projector 12.

In an exemplary embodiment, the adjusting, with the beam steering device 22, the look down angle, further includes adjusting, with a beam steering device 22 that includes a liquid crystal lens 44 adapted to steer the holographic image 18 passing through the beam steering device 22 upon application of voltage to the beam steering device 22, the look down angle.

In another exemplary embodiment, the adjusting, with the beam steering device 22 that includes a liquid crystal lens 44 adapted to steer the holographic image 18 passing through the beam steering device 22 upon application of voltage to the beam steering device 22, the look down angle, further includes selectively changing birefringent characteristics of the liquid crystal lens 44 by varying the voltage supplied to the liquid crystal lens 44.

In another exemplary embodiment, the adjusting, with the beam steering device 22 that includes a liquid crystal lens 44 adapted to steer the holographic image 18 passing through the beam steering device 22 upon application of voltage to the beam steering device 22, the look down angle, further includes selectively changing the orientation of liquid crystal molecules 46 within the liquid crystal lens 44 by varying the voltage supplied to the liquid crystal lens 44. The selectively changing the orientation of liquid crystal molecules 46 by varying the voltage supplied to the liquid crystal lens 44 includes one of rotating the liquid crystal molecules 46 about an axis 48 that is parallel to a direction of the holographic image 18 entering the beam steering device 22, and rotating the liquid crystal molecules 46 about an axis 58 that is perpendicular to a direction of the holographic image 18 entering the beam steering device 22.

In still another exemplary embodiment, the adjusting, with the beam steering device 22, a look down angle, further includes adjusting, with a beam steering device 22 that includes a first circular wedge prism 64A and a second circular wedge prism 64B adapted to steer the holographic image 18 passing through the beam steering device 22 upon rotation of the first circular wedge prism 64A and the second circular wedge prism 64B about an axis 66 parallel to the path 68 of the holographic image 18 entering the beam steering device 22.

Moving to block 110, the method further includes determining if the LDA adjustment is sufficient to accommodate for the variance of the vertical eye position relative to the nominal vertical position 34A. If the LDA adjustment is sufficient, the method loops back to block 102, as indicated by arrow 116. If the LDA adjustment is not sufficient, then, moving to block 112, the method includes adjusting, with the controller 24, the virtual image distance of the virtual image 30 projected by the hologram projector 12 by using the controller 24 to encode a lens function into the holographic image 18 projected by the hologram projector 12. Finally, the method 100 loops back to block 102, as indicated by arrow 118.

A HUD system 10 and method 100 of the present disclosure offers the advantage of ensuring that the virtual image 30 appears to the driver at the same location 38A on the road surface 36 for varying vertical eye positions.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method of controlling a head up display system for an automobile, comprising:
locating, with a driver monitoring system, the vertical location of a driver's eyes;
comparing, with a controller, the vertical location of the driver's eyes to a pre-determined nominal vertical position;
adjusting, with a beam steering device, a look down angle of a holographic image projected by a hologram projector, wherein the beam steering device includes a liquid crystal lens adapted to steer light passing through the beam steering device upon application of voltage to the beam steering device, and selectively changing birefringent characteristics of the liquid crystal lens by varying the voltage supplied to the liquid crystal lens; and
adjusting, with the controller, a virtual image distance of the holographic image projected by the hologram projector.

2. The method of claim 1, wherein the comparing, with the controller, the vertical location of the driver's eyes to the pre-determined nominal vertical position, further includes, determining the distance that the vertical location of the driver's eyes varies from the pre-determined nominal vertical position.

3. (canceled)

4. (canceled)

5. The method of claim 1, wherein the adjusting, with the beam steering device that includes a liquid crystal lens adapted to steer light passing through the beam steering device upon application of voltage to the beam steering device, the look down angle, further includes selectively changing the orientation of liquid crystal molecules within the liquid crystal lens by varying the voltage supplied to the liquid crystal lens.

6. The method of claim 5, wherein the selectively changing the orientation of liquid crystal molecules by varying the voltage supplied to the liquid crystal lens further includes, rotating the liquid crystal molecules about an axis that is parallel to a direction of the light entering the beam steering device.

7. The method of claim 5, wherein the selectively changing the orientation of liquid crystal molecules by varying the voltage supplied to the liquid crystal lens further includes, rotating the liquid crystal molecules about an axis that is perpendicular to a direction of the light entering the beam steering device.

8. The method of claim 2, wherein the adjusting, with the beam steering device, a look down angle, further includes adjusting, with a beam steering device that includes a first circular wedge prism and a second circular wedge prism adapted to steer light passing through the beam steering device upon rotation of the first circular wedge prism and the second circular wedge prism, the look down angle.

9. The method of claim 8, wherein the adjusting, with the beam steering device that includes a first circular wedge prism and a second circular wedge prism adapted to steer light passing through the beam steering device upon rotation of the first circular wedge prism and the second circular wedge prism further includes, selectively rotating the first circular wedge prism and the second circular wedge prism about an axis parallel to a direction of the light entering the beam steering device.

10. A head-up display system, comprising:
a hologram projector adapted to project a holographic image;
a beam steering device adapted to adjust a look down angle of a holographic image projected through the beam steering device by the hologram projector, the beam steering device including a liquid crystal lens adapted to steer light passing through the beam steering device upon application of voltage to the beam steering device and to selectively change birefringent characteristics of the beam steering device when voltage supplied to the liquid crystal lens is varied by the controller; and
a controller in communication with the hologram projector and adapted to compare the vertical location of the driver's eyes to a pre-determined nominal vertical position, and to adjust a virtual image distance of the holographic image projected by the hologram projector.

11. The head-up display system of claim 10, wherein the controller is further adapted to determine the distance that the vertical location of the driver's eyes varies from the pre-determined nominal vertical position.

12. (canceled)

13. (canceled)

14. The head-up display system of claim 11, wherein the liquid crystal lens is adapted to selectively steer light passing through the beam steering device by changing the orientation of liquid crystal molecules within the liquid crystal lens when voltage supplied to the liquid crystal is varied by the controller.

15. The head-up display system of claim 14, wherein the liquid crystal molecules within the liquid crystal lens are rotated about an axis that is parallel to a direction of light entering the beam steering device.

16. The head-up display system of claim 14, wherein the liquid crystal molecules within the liquid crystal lens are rotated about an axis that is perpendicular to a direction of light entering the beam steering device.

17. The head-up display system of claim 11, wherein the beam steering device includes a first circular wedge prism and a second circular wedge prism, wherein the first circular wedge prism and the second circular wedge prism are adapted to steer light passing through the beam steering device upon rotation of the first circular wedge prism and the second circular wedge prism.

18. The head-up display system of claim 17, wherein the first circular wedge prism and the second circular wedge prism are selectively and independently rotatable about an axis parallel to a direction of light entering the beam steering device.

19. The head-up display system of claim 11, wherein the controller is adapted to adjust a virtual image distance by encoding a lens function into the holographic image projected by the hologram projector.

20. A head-up display system, comprising:
a hologram projector adapted to project a holographic image;
a beam steering device adapted to adjust a look down angle of a holographic image projected through the beam steering device by the hologram projector; and
a controller in communication with the hologram projector and adapted to compare the vertical location of the driver's eyes to a pre-determined nominal vertical position, to determine the distance that the vertical location of the driver's eyes varies from the pre-determined nominal vertical position, and to adjust a virtual image distance of the holographic image projected by the hologram projector by encoding a lens function into the holographic image projected by the hologram projector;
wherein the beam steering device includes one of:
a liquid crystal lens adapted to selectively change birefringent characteristics of the beam steering device by changing the orientation of liquid crystal molecules within the liquid crystal lens and rotating the liquid crystal molecules about an axis that is one of parallel and perpendicular to a direction of light entering the beam steering device when voltage supplied to the liquid crystal lens is varied by the controller; and
a first circular wedge prism and a second circular wedge prism, each selectively and independently rotatable about an axis parallel to a direction of light entering the beam steering device wherein the first circular wedge prism and the second circular wedge prism are adapted to steer light passing through the beam steering device upon rotation of the first circular wedge prism and the second circular wedge prism.
